(19) United States
(12) Patent Application Publication
(10) Pub. No.: US 2006/0291050 A1
(43) Pub. Date: Dec. 28, 2006

(54) Screen for projection-type 3D image and projection system having the same

(75) Inventors: Sergey Shestak, Suwon-si (KR); Tae-hee Kim, Suwon-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/449,762

(22) Filed: Jun. 9, 2006

(30) Foreign Application Priority Data
Jun. 9, 2005 (KR) 10-2005-0049199

(51) Int. Cl. G03B 21/56

(52) U.S. Cl. 359/443; 359/463

(57) ABSTRACT

A screen and a projection system for producing a projection-type 3D image. The screen separates an image projected from a projector into fields for realizing a 3D image, and includes a birefringence device changing a refractive index according to a polarization direction of an incident beam and a lenticular lens array producing a 3D image using the beam that passed through the birefringence device.

### CROSS-REFERENCE TO RELATED PATENT APPLICATIONS

This application claims priority from Korean Patent Application No. 10-2005-0049199, filed on Jun. 9, 2005, in the Korean Intellectual Property Office, the disclosure of which is incorporated herein in its entirety by reference.

### BACKGROUND OF THE INVENTION

1. Field of the Invention

The present invention relates to a screen for a projection-type three-dimensional (3D) image and a projection system including the same, and, more particularly, to a screen displaying a 3D image using a projector and improving a resolution of the 3D image, and a projection system including the screen.

2. Description of the Related Art

A 3D image is realized according to the principle of stereo vision. Binocular parallax, a characteristic due to the positions of the left eye and right eye located about 65 mm apart from each other, is the most important factor producing a cubic effect. 3D image displays can be displayed by using glasses and glassless displays.

In cases of the 3D image display using glasses, polarization directions of left and right images are different from each other on a projector, and a user sees a 3D image by wearing polarization glasses. Alternately, the left and right images are displayed on a time division basis, and the user sees a 3D image by wearing liquid crystal shutter glasses. In the display method using the polarization glasses, the left image and the right image are divided using a property of different vibration direction of polarization or a property of different rotation direction of circular polarization. Also, polarization plates, polarization directions of which are perpendicular to each other, are formed on a first projector and a second projector representing the left image and the right image simultaneously. Then, the images of the first and second projectors are combined, and the left image and the right image can be divided through the left and right polarization plates, which are perpendicular to each other, and thus, the user can see the 3D image.

The time division method provides left and right images alternately. When the left image is provided, the image is focused on the left eye, and when the right image is provided, the image is focused on the right eye. A time division glass shutter method switches the left and right images using the glasses, and a time division polarization glasses method switches the left and right images on the display. However, according to the method using the glasses, the user should wear the glasses, and thus, the display when glasses are not required may be preferable.

The glassless display obtains a 3D image by separating left/right images without using glasses. The glassless displays are divided into parallax barrier-type displays and lenticular-type displays.

A parallax barrier type display alternately prints images that should be seen respectively by the left and right eyes in the form of a vertical pattern or a photo using an extremely thin vertical lattice column, i.e., a barrier. By doing so, a vertical pattern image that is to be provided to the left eye and a vertical pattern image that is to be provided to the right eye are distributed by the barrier and images from different viewpoints are seen by the left and the right eyes, respectively, so that a stereo image is perceived.

A projection type image display device enlarges an image formed by a display element, projects the enlarged image on a screen unit using a projection lens unit, and realizes a 3D image using a left/right eye image separation unit provided in the screen unit. FIG. 1A is a schematic view of a conventional projection type image display device. The projection type image display device includes a first projector 10 and a second projector 20 and produces a 3D image by separating images into first images from the first projector 10 and second images from the second projector 20 and sending the first and second images to the right eye (RE) and the left eye (LE) using the screen unit S, respectively.

The screen unit S has a parallax barrier 25 in order to separate the images from the projector for the RE and the LE. Referring to FIG. 1A, the parallax barrier 25 has slits 26 and barriers 27 arranged in an alternate manner. The images from the first and second projectors 10 and 20 are separated into the images L for the LE and the images R for the RE by the slits 26 to form a 3D image.

According to such a method, since images are formed and blocked by the slits 26 and the barriers 27, respectively, the images L are formed, e.g., at even-numbered lines only and blocked by the barrier 27 so that black lines K are formed at odd-numbered lines as illustrated in FIG. 1B. Similarly, the images R are formed, e.g., at odd-numbered lines only and blocked by the barrier 27 so that the black lines K are formed at even-numbered lines.

Therefore, the resolution of the display device and the brightness of a 3D image deteriorate. Further, since two projectors are used in order to produce the images L and R, the volume of the device is increased. In addition, the projector should be enlarged in order to realize the 3D images, and production costs of the projector increase.

### SUMMARY OF THE INVENTION

The present invention provides a screen including layers for displaying 3D images without changing a structure of a projector and a projection system including the screen.

According to an aspect of the present invention, there is provided a screen separating an image projected from a projector into fields for realizing a three-dimensional (3D) image, the screen including: a birefringence device changing a refractive index according to a polarization direction of an incident beam; and a lenticular lens array imaging the beam that passed through the birefringence device.

The screen may further include: a quarter wave plate disposed between the birefringence device and the lenticular lens array for converting the polarization direction of the beam that passed through the birefringence device.

The screen may further include: a diffuser retro-reflecting the beam that passed through the lenticular lens array back toward the birefringence device.

The diffuser may be disposed in a focal point of the lenticular lens array.

A prism may be attached on an incident surface of the birefringence device.

The birefringence device may be formed of calcite, nematic liquid crystal, or high-birefringence optics.

The high-birefringence optics may have a degree of birefringence within a range of 0.1-0.5.

When a normal refractive index of the birefringence device is “no” and an abnormal refractive index of the birefringence device “ne”, a refractive index of the prism may be (no+ne)/2.

According to another aspect of the present invention, there is provided a projection system including: a projector including: a display panel producing an image by converting an incident beam according to a first field image signal and a second field image signal that are sequentially input into the display panel, a polarization conversion device sequentially converting polarization directions incident beams onto the polarization conversion device in synchronization with a first field image beam and a second field image beam output from the display panel, and a projection lens unit enlarging and projecting the first field image and the second field image; and a screen including a birefringence device changing a refractive index according to a polarization direction of beam output from the projector; and a lenticular lens array producing image using the beam that passed through the birefringence device, to separate the first field image and the second field image and to form a 3D image.

According to another aspect of the present invention, there is provided a projection system including: a projector including: a first display panel forming a first field image by spatially converting an incident beam onto the first display panel according to an input first field image signal; a second display panel forming a second field image by spatially converting an incident beam onto the second display panel according to an input second field image signal; a polarization conversion device sequentially converting polarization directions in synchronization with a first field image beam and a second field image beam output from the display panel; and a projection lens unit enlarging and projecting the first field image and the second field image; and a screen including a birefringence device changing a refractive index according to a polarization direction of beam output from the projector; and a lenticular lens array producing an image using the beam that passed through the birefringence device, to separate the first field image and the second field image to form a 3D image.

### BRIEF DESCRIPTION OF THE DRAWINGS

The above and other features and aspects of the present invention will become more apparent by describing in detail exemplary embodiments thereof with reference to the attached drawings in which:

FIG. 1A is a schematic view of a conventional projection type parallax-barrier type 3D image display device;

FIG. 1B is a view illustrating images for the left eye and images for the right eye displayed by the 3D image display device of FIG. 1A;

FIG. 2 is a view of a projection system including a screen and a projector according to an exemplary embodiment of the present invention;

FIGS. 3A and 3B are views illustrating operations of a birefringence device formed on the screen according to the exemplary embodiment of the present invention;

FIG. 4 is a view illustrating changes of paths of a first polarization beam and a second polarization beam that are double-refracted by a prism and the birefringence device formed on the screen according to the exemplary embodiment of the present invention;

FIG. 5 is a detailed view illustrating processes for realizing a 3D image using the screen according to the exemplary embodiment of the present invention; and

FIG. 6 is a view of a projection system including a two-panel projector according to another exemplary embodiment of the present invention.

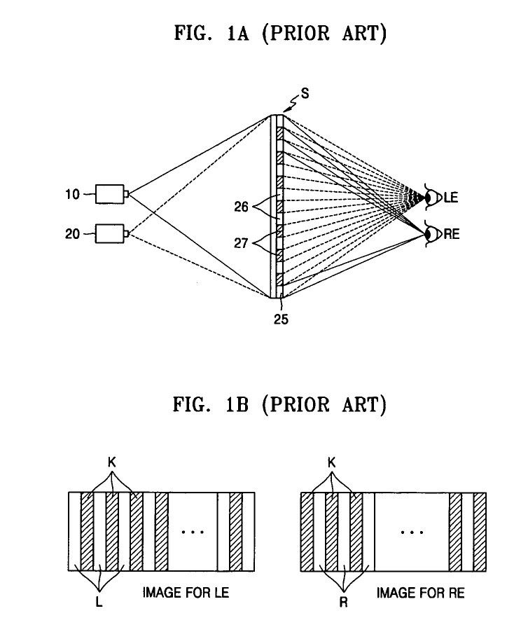

### DETAILED DESCRIPTION OF ILLUSTRATIVE, NON-LIMITING, EMBODIMENTS OF THE INVENTION

Exemplary embodiments of the invention will now be described below by reference to the attached figures. The described exemplary embodiments are intended to assist the understanding of the invention, and are not intended to limit the scope of the invention in any way.

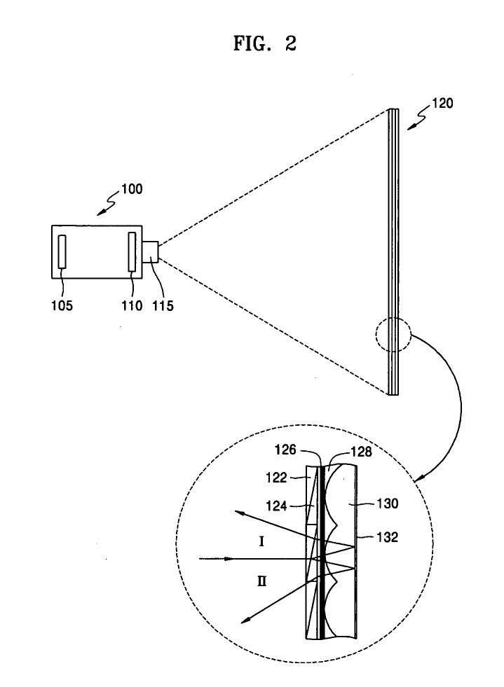

Referring to FIG. 2, a projection system according to an exemplary embodiment of the present invention includes a projector 100 enlarging and projecting an image formed by a display panel 105, and a screen 120 providing a viewing zone and displaying the image as a 3D image.

The projector 100 includes a display panel 105 processing an incident beam according to an input image signal to form an image, a polarization conversion device 110 switched in synchronization with the image signal input into the display panel 105, and a projection lens unit 115 enlarging and projecting the image onto the screen 120.

The display panel 105 can be a liquid crystal display (LCD) or a ferro liquid crystal display (FLCD) that depends on a polarization, and may be a projection type or a reflection type display. The polarization conversion device 110, for example, a liquid crystal polarization converter, selectively applies power to a pixel unit to convert a polarization direction of the incident light.

The image signal of one frame input into the display panel 105 includes a first field image signal for the left eye (LE) and a second field image signal for the right eye (RE), and the first and second field image signals are input into the display panel 105 time-sequentially. When the first field image signal is input into the display panel 105, an external voltage is applied to the polarization conversion device 110, and thus, the first field image exits the polarization conversion device 110 as a first polarization beam, for example, P polarization beam without changing its polarization direction. When the second field image signal is input into the display panel 105, the external voltage is turned off, and thus, the incident light exits the polarization conversion device 110 as a second polarization beam, for example, S polarization beam after changing its polarization direction.

The first field image and the second field image exit from the display panel 105 time-sequentially with different polarization directions from each other, and are enlarged and projected on the screen 120 through the projection lens unit 115.

The screen 120 includes a birefringence device 124 of which a refractive index changes according to the polarization direction of the incident light, a diffuser 132 retro-reflecting the beam passed through the birefringence device 124 to the birefringence device 124 again, a quarter wave plate 126 disposed between the birefringence device 124 and the diffuser 132 and converting the polarization direction of the incident light, and a lenticular lens array 130.

A normal beam having a polarization direction parallel to a crystal optical axis of the birefringence device 124 is projected straight according to a normal refractive index (no) of the birefringence device 124, and an abnormal beam having a polarization direction perpendicular to the crystal optical axis of the birefringence device is refracted according to an abnormal refractive index (ne). Therefore, when the first and second polarization beams pass through the birefringence device 124, they are refracted at different angles from each other. The birefringence device 124 can be formed, for example, of calcite, nematic liquid crystal, or high-birefringence optics. The high-birefringence optics has a birefringence range of 0.1-0.5, and thus, it has a relatively higher birefringence degree than that of the general birefringence device. For example, the calcite has a birefringence degree of about 0.2.

The normal refractive index (no) and the abnormal refractive index (ne) of the materials for the birefringence device are shown in following table.

TABLE 1

| Crystal | no | Ne |
|---|---|---|
| tourmaline | 1.669 | 1.638 |
| calcite | 1.6584 | 1.4864 |
| quartz(SiO2) | 1.5443 | 1.5534 |
| Ice | 1.309 | 1.313 |
| rutile(TiO2) | 2.616 | 2.903 |

When the birefringence device 124 is fabricated using high-birefringence optics, properties of the device 124 are shown in following table in comparison to the properties of a device formed of a general birefringence material.

TABLE 2

| | Multi-layered filter | |
|---|---|---|
| | formed of inorganic | |
| | material on glass | High-birefringence |
| Property | substrate | polymer filter |
| Layers | 10-200 | 100-1000 |
| Range of refractive index | 1.3-2.4 | 1.45-1.75 |
| Birefringence degree | Small | 0.1-0.5 |
| Thickness | 1-3 mm | 0.025-0.2 mm |
| Band shift at 45° | −10% | −11% |
| gradient | | |
| Band shift at temperature | parts-per-million | parts-per-thousand |
| of 20° C. | | |
| Flexibility | No | Yes |
| Formability | No | Yes |
| Maximum temperature | Higher than 100° C. | 100-160° C. |

In the case of a large screen, it is preferable, but not necessary, that the birefringence device 124 is fabricated using high-birefringence optics, which is easily fabricated as a sheet, rather than the calcite. In addition, when the degree of birefringence is large, the image largely shifts due to the refraction, and thus, it is advantageous to realize a 3D image.

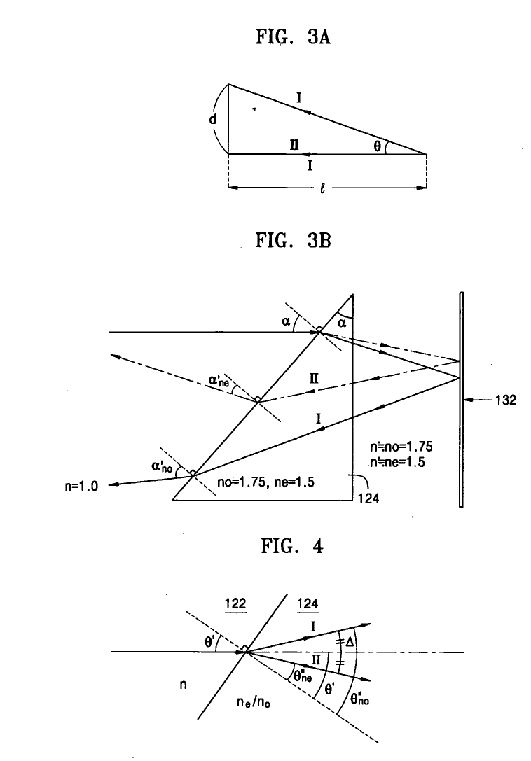

The birefringence device 124 can select a vertex angle (α) in order to maintain a specific distance between the image for LE and the image for RE at a specific viewing distance. Referring to FIG. 3A, when the viewing distance is l and the distance between the left eye and the right eye is d, an angle θ between the first polarization beam I and the second polarization beam II is as follows.

$$θ = {tan}^{- 1} ( \frac{d}{l} ) \qquad ( 1 )$$

FIG. 3B is a schematic view of the birefringence device 124 and the diffuser 132 in order to illustrate the relations between the vertex angle α of the birefringence device 124, the viewing distance l, and the distance d between the left and right eyes.

According to Equation 1, the angle θ between the first polarization beam I and the second polarization beam II is equal to the difference between an exit angle α′ne of the first polarization beam and an exit angle α′no of the second polarization beam, and can be represented as follows.
θ=a′ₙₒ−a′ₙₑ (2)

According to Snell's law, Equation (2) can be represented as follows.
θ=sin⁻¹(no sin 2a)−sin⁻¹(ne sin 2a) (3)

When no and ne are determined, the vertex angle α of the birefringence device 124 can be calculated according to the value of θ in Equation 3. In addition, according to the vertex angle α, the exit angle α′ₙₑ of the first polarization beam and the exit angle α′ₙₒ of the second polarization beam can be determined.

For example, when the viewing distance is 1 m, the distance between the left and right eyes is 6.5 cm, no is 1.75, and ne is 1.5, the vertex angle α of the birefringence device 124 is about 6.8°, and α′ne is 20.96° and α′no is 24.67°.

In addition, the birefringence device 124 is formed as a trigonal prism, and a prism sheet can be formed by bonding a prism 122 onto the birefringence device 124. The prism 122 is disposed on a light incident surface, and the birefringence device 124 is disposed on a light exit surface. The prism 122 and the birefringence device 124 may form an array, or one prism 122 and one birefringence device may be formed in the prism sheet.

The prism 122 can be formed of, for example, an ultraviolet (UV)-curing plastic, the incident angle of the beam with respect to the birefringence device 124 after passing through the prism 122 is determined according to the refractive index of the prism 122, and consequently, the prism 122 affects the paths of the first and second polarization beams I and II. If it is desired that the first and second polarization beams I and II exit symmetrically from the screen, the refractive index n of the prism 122 may be set such that n=(no+ne)/2. For example, when no is 1.41 and ne is 1.59, n is 1.5.

Referring to FIG. 4, when the incident angle of the beam for the birefringence device 124 is θ′, a refraction angle of the first polarization beam is θ″no, and a refraction angle of the second polarization beam is θ″ne, and the following equation can be written according to Snell's law.

$$sin {θ}_{{ne}^{″}} = \frac{n sin {θ}^{′}}{ne} , \\ sin {θ}_{{no}^{″}} = \frac{n sin {θ}^{′}}{ no} \qquad ( 4 )$$

In more detail, when the incident angle θ′ is 10°, half angles Δ of the birefringence exit angles of the first and second polarization beams I and II are 0.6°, and the refractive index n of the prism 122 is 1.5, θne′ is 9.4° and θno′ is 10.6°.

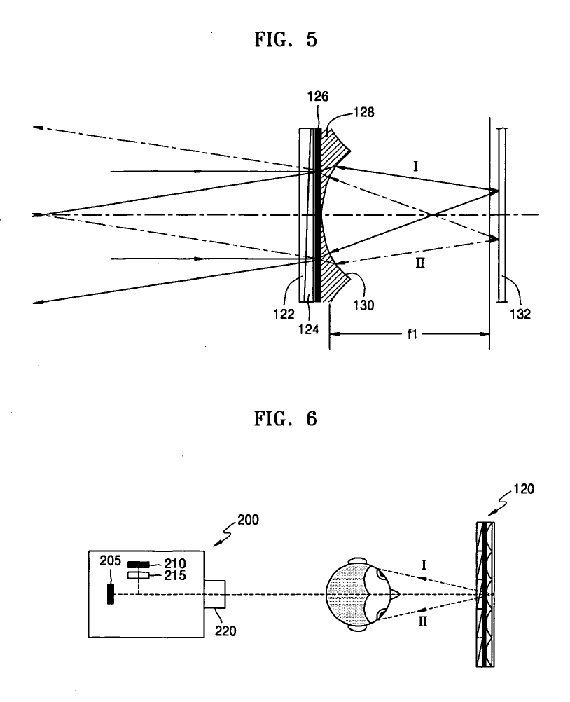

Referring to FIG. 5, the first polarization beam I and the second polarization beam II, optical paths of which are divided by the birefringence device 124, pass the lenticular lens array 130 and are focused onto the diffuser 132. The diffuser 132 is a reflective type and can be located on a focal length f1 of the lenticular lens array 130. In the above structure, the beams incident in parallel are refracted by the lenticular lens array 130, and focused onto the diffuser 132. Then, the beam is retro-reflected exactly along the incident path. Moreover, if the prism 122 satisfies conditions of symmetric refraction, the beams incident onto the screen and parallel to each other are refracted symmetrically based on an optical axis as shown in FIG. 5, and produce images, which are symmetric with each other based on the optical axis, on the diffuser 132 located on the focal point of the lenticular lens array 130, and then, are retro-reflected along the same incident light paths.

The quarter wave plate 126 changing the polarization direction of the incident beam is disposed between the birefringence device 124 and the lenticular lens array 130. The quarter wave plate 126 divides the beam retro-reflected by the diffuser 132 into the images for the LE and the RE, and allows the images for the LE and the RE to be condensed into the left eye and the right eye, respectively. In more detail, the first polarization beam, for example, the S polarization beam, and the second polarization beam, for example, the P polarization beam, that are refracted at different angles from each other by the birefringence device 124 are converted into left polarization beam and right polarization beam, and after that, are incident onto the diffuser 132 after passing through the lenticular lens array 130. The polarization directions of the beams incident onto the diffuser 132 are changed, that is, the left polarization beam is retro-reflected as the right circular polarization beam and the right polarization beam is retro-reflected as the left circular polarization beam. After that, the polarization directions are changed again through the quarter wave plate 126, and thus, the right circular polarization beam and the left circular polarization beam are incident onto the birefringence device 124 as the first polarization beam of P polarization and the second polarization beam of S polarization. In addition, the beams are projected with different refractive indices from each other according to the polarization directions thereof by the birefringence device 124, and thus, the image for the LE and the image for RE can be separated, and thereby produce a 3D image.

The quarter wave plate 126 and the lenticular lens array 130 are sealed to each other by a sealing material 128 such as a silicon sealant, and the sealing material 128 may have a smaller refractive index than the lenticular lens array 130.

FIG. 6 illustrates a system including a projector 200 having two display panels. The projector 200 includes a first display panel 205 and a second display panel 210, and converts a polarization direction of a beam emitted from one of the first and second display panels 205 and 210 using a polarization conversion device 215. The first display panel 205 forms, for example, an image for the right eye, and the second display panel 210 forms an image for the left eye, and the images for the right and left eyes are emitted simultaneously. In addition, the polarization direction of the beam emitted from the second display panel 210 is converted by the polarization conversion device 215, and thus, the polarization directions of the images for the right and left eyes become different from each other, and then, the images are enlarged and projected onto the screen 120 using a projection lens unit 220. The screen 120 is the same as that in the above exemplary embodiment, and thus, detailed descriptions for the screen 120 are omitted.

The two-panel projector shown in FIG. 6 outputs the images for the LE and the RE simultaneously, and the one-panel projector shown in FIG. 2 outputs the images for the LE and RE time-sequentially.

According to the 3D screen and projection system of the exemplary embodiment of the present invention, the image beam for the left eye and the image beam for the right eye have different polarization directions and are refracted at different angles from each other, thereby forming a 3D image. Therefore, there is no need to modify the conventional projector, and when the screen of the exemplary embodiment of the present invention is used, a user can view a 3D image. In addition, since the image for the left eye and the image for the right eye are separated using the birefringence device, the resolution of the 3D image is not degraded compared to that of the 2D image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A screen separating an image projected from a projector into fields for realizing a three-dimensional (3D) image, the screen comprising:
a birefringence device changing a refractive index according to a polarization direction of an incident beam; and
a lenticular lens array imaging the beam that passed through the birefringence device.

2. The screen of claim 1, further comprising:
a quarter wave plate disposed between the birefringence device and the lenticular lens array for converting the polarization direction of the beam that passed through the birefringence device.

3. The screen of claim 1, further comprising:
a diffuser retro-reflecting the beam that passed through the lenticular lens array back toward the birefringence device.

4. The screen of claim 3, wherein the diffuser is disposed at a focal point of the lenticular lens array.

5. The screen of claim 1, wherein a prism is attached on an incident surface of the birefringence device.

6. The screen of claim 5, wherein the prism and the birefringence device form an array.

7. The screen of claim 1, wherein the birefringence device is formed of at least one of calcite, nematic liquid crystal, and high-birefringence optics.

8. The screen of claim 7, wherein the high-birefringence optics has a degree of birefringence within a range of 0.1-0.5.

9. The screen of claim 5, wherein, when a normal refractive index of the birefringence device is “no” and an abnormal refractive index of the birefringence device is “ne”, a refractive index of the prism is (no+ne)/2.

10. A projection system comprising:
a projector including: a display panel producing an image by converting an incident beam according to a first field image signal and a second field image signal that are sequentially input into the display panel, a polarization conversion device sequentially converting polarization directions incident beams onto the polarization conversion device in synchronization with a first field image beam and a second field image beam output from the display panel, and a projection lens unit enlarging and projecting the first field image and the second field image; and
a screen including a birefringence device changing a refractive index according to a polarization direction of the beams output from the projector; and a lenticular lens array producing image using the beams that passed through the birefringence device, to separate the first field image and the second field image and to form a 3D image.

11. The projection system of claim 10, wherein a quarter wave plate for converting the polarization direction of the beams that passed through the birefringence device is disposed between the birefringence device and the lenticular lens array.

12. The projection system of claim 10, further comprising:
a diffuser retro-reflecting the beams that passed through the lenticular lens array back toward the birefringence device.

13. The projection system of claim 10, wherein the birefringence device is formed of at least one of calcite, nematic liquid crystal, and high-birefringence optics.

14. The projection system of claim 13, wherein the high-birefringence optics has a degree of birefringence within a range of 0.1-0.5.

15. The projection system of claim 10, wherein a prism is attached to an incident surface of the birefringence device, and when a normal refractive index of the birefringence device is “no” and an abnormal refractive index of the birefringence device is “ne”, a refractive index of the prism is (no+ne)/2.

16. The projection system of claim 10, wherein the display panel is a liquid crystal display (LCD) or a ferro-liquid crystal display (FLCD).

17. A projection system comprising:
a projector including: a first display panel forming a first field image by spatially converting an incident beam onto the first display panel according to an input first field image signal; a second display panel forming a second field image by spatially converting an incident beam onto the second display panel according to an input second field image signal; a polarization conversion device sequentially converting polarization directions in synchronization with a first field image beam and a second field image beam output from the display panel; and a projection lens unit enlarging and projecting the first field image and the second field image; and
a screen including a birefringence device changing a refractive index according to a polarization direction of the beams output from the projector; and a lenticular lens array producing an image using the beams that passed through the birefringence device, to separate the first field image and the second field image to form a 3D image.

18. The projection system of claim 17, wherein a quarter wave plate for converting the polarization beam of the beams that passed through the birefringence device is disposed between the birefringence device and the lenticular lens array.

19. The projection system of claim 17, further comprising:
a diffuser retro-reflecting the beams that passed through the lenticular lens array back toward the birefringence device.

20. The projection system of claim 17, wherein the diffuser is disposed at a focal point of the lenticular lens array.

21. The projection system of claim 17, wherein a prism is attached on an incident surface of the birefringence device.1

22. The projection system of claim 21, wherein the prism and the birefringence device form an array.

23. The projection system of claim 17, wherein the birefringence device is formed of at least one of calcite, nematic liquid crystal and high-birefringence optics.

24. The projection system of claim 23, wherein the high-birefringence optics has a degree of birefringence within a range of 0.1-0.5.

25. The projection system of claim 21, wherein, when a normal refractive index of the birefringence device is “no” and an abnormal refractive index of the birefringence device is “ne”, a refractive index of the prism is (no+ne)/2.

26. The projection system of claim 17, wherein the display panel is a liquid crystal display (LCD) or a ferro-liquid crystal display (FLCD).

27. The projection system of claim 17, wherein the polarization conversion device is a liquid crystal polarization switch.
